(19) United States
(12) Patent Application Publication
(10) Pub. No.: US 2022/0258411 A1
(43) Pub. Date: Aug. 18, 2022

(54) PROCESS

(71) Applicant: Johnson Matthey Public Limited Company, London (GB)

(72) Inventors: Jonathan EDGAR, Billingham (GB); Michele MARIGO, Billingham (GB); Gina MERCIER, Billingham (GB)

(21) Appl. No.: 17/597,640

(22) PCT Filed: Jul. 15, 2020
(86) PCT No.: PCT/GB2020/051698

§ 371 Date: Jan. 14, 2022

(30) Foreign Application Priority Data
Jul. 15, 2019 (GB) 1910106.2

(51) Int. Cl. B29C 64/135; B33Y 10/00; B33Y 80/00; B29C 64/268; B33Y 30/00

(52) U.S. Cl. CPC B29C 64/135; B33Y 10/00; B29K 2105/0029; B29C 64/268; B33Y 30/00; B33Y 80/00

(57) ABSTRACT

The present invention relates to additive layer manufacture methods for producing a cured three-dimensional polymerized object, or an object comprising cured polymer on, in and/or around the object, or part thereof. A bittering agent is distributed within the cured polymer.

The present invention relates to the manufacture of three-dimensional objects by polymerization additive layer manufacture techniques, and the three-dimensional objects produced according to the polymerization ALM techniques.

Additive layer manufacturing (ALM) is a technique whereby 2-dimensional layers of powdered or liquid materials are sequentially laid down and fused or bound together to form 3-dimensional solid objects. The technique has been developed for the fabrication of metal, ceramic and polymeric components for use in aerospace and medical applications.

Vat-photopolymerization additive layer manufacture (VP-ALM) utilizes a photocurable liquid feedstock to form 3-dimensional solid objects. The feedstock is exposed to a light source in a controlled manner to build the solidified object in 2-dimensional slices. The light source may be a laser that scans over the exposure layer or a projected image that illuminates the entire layer in a single exposure. Transition between layers may be discrete or continuous depending on the architecture of the VP-ALM machine.

Denatonium benzoate is considered to be the bitterest substance known to humankind and its taste is extraordinarily bitter to people at ppm levels. Bittering agents, including denatonium benzoate, are commonly used to prevent ingestion to harmful substances for vulnerable beings i.e. those unaware of the hazards. In addition, bittering agents can be applied to prevent damage to critical equipment/infrastructure by vermin.

The incorporation of bittering agents, such as denatonium benzoate, into liquids (e.g. automotive screen wash, antifreeze, and detergents) is known, as is the coating of bittering agents onto the outside of solid objects (e.g. plastic cable sheathing).

U.S. Pat. No. 6,468,554 (to Ted Ichino) describes dissolving denatonium benzoate in molten flexible polyvinyl chloride. The molten plastic material is coaxially extruded to form a cylindrical sheath. U.S. Pat. No. 6,468,554 does not disclose a method for forming three-dimensional objects with complex geometries nor additive layer manufacture methods.

It is an object of the invention to provide a three-dimensional object, which is non-edible in normal use, and which has a high degree of safety for vulnerable people. In certain embodiments, the three-dimensional object is repellent to animals.

Accordingly, the invention provides an additive layer manufacture method for producing a three-dimensional object, the method comprising the steps of:
(i) forming a feedstock comprising a polymerizable liquid resin and a bittering agent;
(ii) exposing the feedstock to a curing beam according to a predetermined pattern to form a layer of cured polymer; and
(iii) repeating step (ii) layer upon layer to form a cured three-dimensional polymerized object.

The majority of polymer parts are thermo-formed i.e. by melting the polymer and forcing/pouring into a mold. This approach restricts the potential of adding the bittering agent, such as denatonium benzoate, as it begins to decompose at about 160-180° C. Many polymers have melting points at, near or above this temperature and therefore at the least some of the bittering agent, such as denatonium benzoate, will decompose on exposure to heat. As a result, the efficacy of the bittering or aversive properties in the product will be limited.

As the ALM method does not require temperature to form solid polymer parts, the bittering agent may be mixed into the liquid feedstock for any resin applied to this technology. In one embodiment, the ALM method is electron beam curing. In another embodiment, the ALM is vat photopolymerization ALM (VP-ALM).

“Curing” is the chemical process of converting a prepolymer or a polymer into a polymer of higher molar mass and then into a network. Curing is achieved by the induction of chemical reactions which might or might not require mixing with a chemical curing agent (IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8.https://doi.org/10.1351/goldbook.).

The curing beam is a charged particle beam and may comprise electromagnetic radiation (when the ALM method is photopolymerization) or electron beams (when the ALM method is electron beam curing).

Electron beam curing involves projecting electron beams at a polymerizable liquid resin. Unlike photopolymerisation, electron beam curing does not require a photoinitiator. The electron beams may be high or low energy beams. High energy beams may be split into multiple low energy beams, typically of the same or substantially the same energy.

Descriptions of photopolymerization processes and equipment may be found in “Additive Manufacturing Technologies—Rapid Prototyping to Direct Digital Manufacturing” by Ian Gibson, David W. Rosen and Brent Stucker, 15 Spring (2010). Photopolymerization involves curing a photocurable liquid resin to form chemically cross-linked polymers. The polymerizable liquid resin may comprise a mixture of multifunctional monomers and oligomers. Oligomers are typically epoxides, urethanes, polyethers, or polyesters, each of which provide specific properties to the resulting material. Each of these oligomers are typically functionalized by an acrylate. The curing forms what is known as a network polymer. Often the photocurable liquid resin will contain a photoinitiator. Photoinitiators are compounds that upon radiation of light decompose into reactive species that activate polymerization of specific functional groups on the oligomers. There are two general routes for photoinitiation: free radical and ionic, either of which may be used.

Suitable photocurable liquid resins may include acrylate oligomers, which may be used in combination with a wide variety of reactive monomers or other oligomers and photo-initiators. The photocurable liquid resin should allow sufficient cross-linking and should ideally be designed to have a minimal volume shrinkage upon polymerization in order to avoid distortion of the cured 3D object. Common monomers utilized for imaging include multifunctional acrylates and methacrylates, often combined with a non-polymeric component in order to reduce volume shrinkage. A competing composite mixture of epoxide resins with cationic photoinitiators is becoming increasingly used since their volume shrinkage upon ring-opening polymerization is significantly below those of acrylates and methacrylates. Free-radical and cationic polymerizations composed of both epoxide and acrylate monomers may also be used, providing the high rate of polymerization from the acrylic monomer, and better mechanical properties from the epoxy matrix. Suitable photocurable liquid resins are available commercially. In one embodiment, the photocurable liquid resin may be selected from the group consisting of CPS2030, Genesis, and ENG1.

When a photoinitiator is used, it is tuned to a wavelength which does not facilitate the degradation of the bittering agent. In one embodiment, the photoinitiator absorption wavelength may be ≥about 200 nm to ≤about 700 nm. In one embodiment, the photoinitiator absorption wavelength may be ≥about 250 nm. In another embodiment, the photoinitiator absorption wavelength may be ≥about 300 nm. In another embodiment, the photoinitiator absorption wavelength may be ≥about 350 nm. In another embodiment, the photoinitiator absorption wavelength may ≥be about 400 nm. In another embodiment, the photoinitiator absorption wavelength may be ≤about 650 nm. In another embodiment, the photoinitiator absorption wavelength may be ≤about 600 nm. In another embodiment, the photoinitiator absorption wavelength may be ≤about 550 nm. In another embodiment, the photoinitiator absorption wavelength may be ≤about 500 nm. In another embodiment, the photoinitiator absorption wavelength may be ≤about 475 nm. In one embodiment, the photoinitiator absorption wavelength may be ≥about 365 nm to ≤about 460 nm.

In one embodiment, the photoinitiator absorption wavelength may be about 365 nm. In another embodiment, the photoinitiator absorption wavelength may be about 460 nm. In another embodiment, the photoinitiator absorption wavelength may be about 405 nm.

The photocurable liquid resin may also comprise additional components, such as pigment or light blockers.

By incorporating the bittering agent into the resin for the forming technology (for example, VP-ALM), it is possible to form any desired shape capable of being produced with this technology. A particular example that would benefit significantly from this property is the manufacture of in-ear hearing aid shells. These devices are currently made (almost predominantly) by VP-ALM and would benefit from having the bittering agent incorporated to prevent ingestion by children, vulnerable people or pets.

An added benefit of having the bittering agent dispersed throughout the entire body is for the event of fracture/breakage of the product such that interior surfaces or pieces will also possess bitter properties.

This is in contrast to objects coated on the outside with a bittering agent formulation which will not possess bitter properties throughout the whole product.

The bittering agent may be selected from the group consisting of denatonium benzoate, denatonium saccharide, quinine hydrochloride, naringin, sucrose octaacetate, and mixtures thereof. In one embodiment, the bittering agent is denatonium benzoate.

The denatonium benzoate may be incorporated into the polymerizable liquid resin as a solid, for example, as anhydrous crystals. In this instance, the denatonium benzoate may be ground by any suitable means into a fine powder (e.g. using a pestle and mortar) before incorporation into the resin.

Alternatively, the denatonium benzoate may be incorporated into the resin as a solution in a solvent. Examples include but are not limited to denatonium benzoate in a glycol, such as monoethylene glycol or propylene glycol.

Any suitable quantity of bittering agent may be added to the polymerizable liquid resin provided the quantity is sufficient for the shaped product to retain its bitter properties after manufacture. It is envisaged that the maximum quantity of bittering agent in the polymerizable liquid resin will be up to the limits imposed by the solubility and/or dispersion of the bittering agent in the polymerizable liquid resin. In one embodiment, the concentration of bittering agent in the feedstock is from about 100 ppm to about 10,000 ppm, for example about 100 ppm to about 5000 ppm. In one embodiment, the concentration of bittering agent in the feedstock is ≥about 150 ppm. In another embodiment, the concentration of bittering agent in the feedstock is ≥about 200 ppm. In another embodiment, the concentration of bittering agent in the feedstock is ≥about 250 ppm. In another embodiment, the concentration of bittering agent in the feedstock is ≥about 300 ppm. In another embodiment, the concentration of bittering agent in the feedstock is ≥about 350 ppm. In another embodiment, the concentration of bittering agent in the feedstock is ≥about 400 ppm. In another embodiment, the concentration of bittering agent in the feedstock is ≥about 450 ppm. In another embodiment, the concentration of bittering agent in the feedstock is ≤about 9000 ppm. In another embodiment, the concentration of bittering agent in the feedstock is ≤about 8000 ppm. In another embodiment, the concentration of bittering agent in the feedstock is ≤about 7000 ppm. In another embodiment, the concentration of bittering agent in the feedstock is ≤about 6000 ppm. In another embodiment, the concentration of bittering agent in the feedstock is ≤about 5000 ppm. In another embodiment, the concentration of bittering agent in the feedstock is ≤about 4500 ppm. In another embodiment, the concentration of bittering agent in the feedstock is ≤about 4000 ppm. In another embodiment, the concentration of bittering agent in the feedstock is ≤about 3500 ppm. In another embodiment, the concentration of bittering agent in the feedstock is ≤about 3000 ppm. In another embodiment, the concentration of bittering agent in the feedstock is ≤about 2500 ppm. In another embodiment, the concentration of bittering agent in the feedstock is ≤about 2000 ppm. In another embodiment, the concentration of bittering agent in the feedstock is ≤about 1500 ppm. In one embodiment, the concentration of bittering agent in the feedstock is from ≥about 500 ppm to ≤1100 ppm.

In step (ii), the feedstock is exposed to the curing beam according to a predetermined pattern to form a layer of cured polymer.

The VP-ALM and electron beam curing processes are enabled by conventional 3D design computer packages that allow design of the shaped unit as a simple mesh depiction of the 3D shape, for example, an “STL file”. The mesh depiction is cross-sectioned using the design software into multiple two-dimensional layers, which are the basis for the fabrication process. The fabrication equipment, reading the two-dimensional pattern, sequentially exposes layer upon layer of feedstock to the curing beam corresponding to the 2D slices. In order that the shaped unit has structural integrity, the feedstock is bound or fused together as the layers are deposited. The process of layer deposition and binding or fusion is repeated until a robust shaped unit is generated. The uncured liquid feedstock is readily separated from the shaped unit, e.g. by decanting it into another container.

The electromagnetic radiation may have a wavelength ≥about 200 nm to ≤about 700 nm. In one embodiment, the electromagnetic radiation may have a wavelength ≥about 250 nm. In another embodiment, the electromagnetic radiation may have a wavelength ≥about 300 nm. In another embodiment, the electromagnetic radiation may have a wavelength ≥about 350 nm. In another embodiment, the electromagnetic radiation may have a wavelength ≥about 400 nm. In another embodiment, the electromagnetic radiation may have a wavelength ≤about 650 nm. In another embodiment, the electromagnetic radiation may have a wavelength ≤about 600 nm. In another embodiment, the electromagnetic radiation may have a wavelength ≤about 550 nm. In another embodiment, the electromagnetic radiation may have a wavelength ≤about 500 nm. In another embodiment, the electromagnetic radiation may have a wavelength ≤about 475 nm. In one embodiment, the electromagnetic radiation may have a wavelength ≥about 365 nm to ≤about 460 nm.

In one embodiment, the electromagnetic radiation may have a wavelength of about 365 nm. In another embodiment, the electromagnetic radiation may have a wavelength of about 405 nm. In another embodiment, the electromagnetic radiation may have a wavelength of about 460 nm.

The feedstock is exposed to the electromagnetic radiation for a period of time sufficient to produce a suitably thick layer of cured polymer. In one embodiment, the exposure time may be from about 1 second to about 60 seconds, for example, about 3 seconds to about 30 seconds, such as about 5 seconds to about 15 seconds.

In step (iii), step (ii) is repeated layer upon layer to form a shaped product.

The cured 3D object comprises one or more layers. In most applications, the cured 3D object comprises a plurality of layers. The number of layers in the object depends on the resolution of the photopolymerization method and the size of the object but may be in the range of 2 to 5000 or higher. The thickness of the layers in the cured 3D object comprising a plurality of layers may be in the range 10 to 300 μm, for example, in the range 20 to 100 μm. The thickness of a base (i.e. first) layer is typically thicker than subsequent build (or attachment) layers. The base layer is often designed to be part of the geometry of the final cured 3D object which is not typically critical to the function of the cured 3D object.

The ALM method may be conducted under conditions which exclude or substantially exclude ambient light sources (i.e. visible or UV electromagnetic radiation or a combination thereof). Methods for excluding or substantially excluding ambient light sources are known to the skilled person.

After the cured 3D polymerized object has been formed, it may be desirable to wash it one or more times with a suitable solvent which is capable of dissolving liquid resin residues (if any) but does not wash out the bittering agent. Suitable solvents include but are not limited to an alcohol (such as 1-propanol or 2-propanol) and propylene carbonate. Alternatively or in addition, excess resin may be removed with compressed air. A solvent-less removal of resin (e.g. using compressed air) may be advantageous as it prevents the possibility of washing out some or all of the bittering agent from the surfaces of cured 3D polymerized object which would otherwise be in contact with the solvent. After washing or other resin-removal method, the cured 3D polymerized object may be dried. Drying may be performed using known methods, for example, at temperatures in the range of about 10° C. to about 60° C., such as about 20° C. to about 40° C., for example, ambient temperature. Drying may be performed under vacuum (for example about 1 mbar to about 30 mbar) for about 1 hour to about 24 hours. It is preferred that the drying conditions are maintained below the point at which the bittering agent degrades and so when the bittering agent is known to degrade within the temperature or pressure ranges given above, the drying conditions should be maintained below the degradation temperature or vacuum.

The cured 3D polymerized object may then be subjected to a subsequent curing step in, for example, a curing chamber. This step which may be performed to carry out additional cross-linking reactions under irradiation i.e. to ensure that any uncured resin has been substantially reacted. Optionally, the samples may be cured between glass slides in order to minimize or eliminate curl of the shaped product due to shrinkage of the polymer.

In another aspect, the invention provides an additive layer manufacture method for producing an object comprising cured polymer on, in and/or around the object, or part thereof, the method comprising the steps of:
(i) forming a feedstock comprising a polymerizable liquid resin and a bittering agent;
(ii) immersing an object, or part thereof, into the feedstock;
(iii) exposing the feedstock to a curing beam according to a predetermined pattern to form a layer of cured polymer on, in and/or around the object, or part thereof; and
(iv) optionally repeating step (iii) layer upon layer to form an object comprising cured polymer on, in and/or around the object, or part thereof.

The ALM method, the feedstock, the polymerizable liquid resin, the bittering agent, the curing beam, the exposure of the feedstock to the curing beam, the predetermined pattern, the layer upon layer formation (if any), and the treatment of the object, or part thereof, after curing are as described above.

The object, or part thereof, may be any suitable object which is capable of withstanding the ALM method without being adversely affected by it. After being subjected to the claimed method, the object, or part thereof, will remain suitable for its originally intended purpose but will possess a high degree of safety for vulnerable people, and/or be repellent to animals due to the presence of the cured polymer containing the bittering agent. For example, it is envisaged that screws may be subjected to the method described above such that the screw heads and/or shanks comprise the cured polymer but not the threads.

In another aspect, the invention provides an additive layer manufacture method for producing an object comprising cured polymer on, in and/or around the object, or part thereof, the method comprising the steps of:
(i) forming a feedstock comprising a polymerizable liquid resin and a bittering agent;
(ii) depositing the feedstock onto, in and/or around an object, or part thereof according to a predetermined pattern;
(iii) exposing the feedstock to a curing beam to form a layer of cured polymer on, in and/or around the object, or part thereof; and
(iv) optionally repeating step (iii) layer upon layer to form an object comprising cured polymer on, in and/or around the object, or part thereof.

The feedstock, the polymerizable liquid resin, the bittering agent, the curing beam, the exposure of the feedstock to the curing beam, the object (or part thereof) and the layer upon layer formation (if any), and the treatment of the object, or part thereof, after curing are as described above.

The feedstock may be deposited onto, in and/or around an object, or part thereof, by any suitable method which forms a film or coating such as printing (e.g. using a k-bar or jet printer), casting, roller application, brushing, spraying or like techniques. The mode by which the feedstock is to be applied may influence the desired viscosity of the feedstock. For example, a feedstock suitable for spraying may need to be less viscous than one which is required for roller application.

The inventors believe that this method may be utilized in UV curable finger nail polishes.

In another aspect, the present invention relates to a cured 3D polymerized object produced according to the described ALM method, wherein the cured 3D polymerized object comprises a bittering agent distributed within the cured polymer.

In one embodiment, the bittering agent is distributed substantially homogeneously within the cured polymer.

In one embodiment, the cured 3D polymerized object is a shell for an in-ear hearing aid.

In another aspect, the present invention relates to a cured 3D polymerized object, wherein the object comprises a cured polymer and a bittering agent, the object comprises multiple layers of individually cured polymer, and the bittering agent is distributed within the individually cured polymer layers.

In one embodiment, the bittering agent is distributed substantially homogeneously within the individually cured polymer layers.

In one embodiment, the cured 3D polymerized object is a shell for an in-ear hearing aid.

In another aspect, the present invention relates to an object, or part thereof, comprising multiple layers of individually cured polymer on, in and/or around the object, or part thereof, wherein a bittering agent is distributed within the individually cured polymer layers.

In one embodiment, the bittering agent is distributed substantially homogeneously within the individually cured polymer layers.

In another aspect, the present invention relates to a feedstock comprising a polymerizable liquid resin and a bittering agent.

The feedstock, the polymerizable liquid resin, and the bittering agent are as described above.

Embodiments and/or optional features of the invention have been described above. Any aspect of the invention may be combined with any other aspect of the invention, unless the context demands otherwise. Any of the embodiments or optional features of any aspect may be combined, singly or in combination, with any aspect of the invention, unless the context demands otherwise.

The invention will now be described further by reference to the following examples, which are intended to illustrate but not limit, the scope of the invention and with reference to the following figures in which:

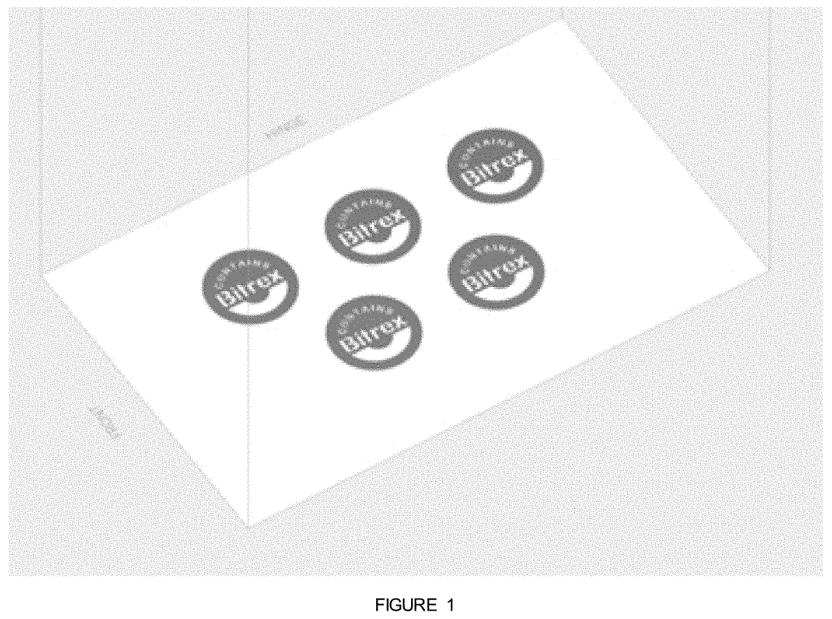

FIG. 1 shows a representative 3D file setup in the print software “Rayware”™.

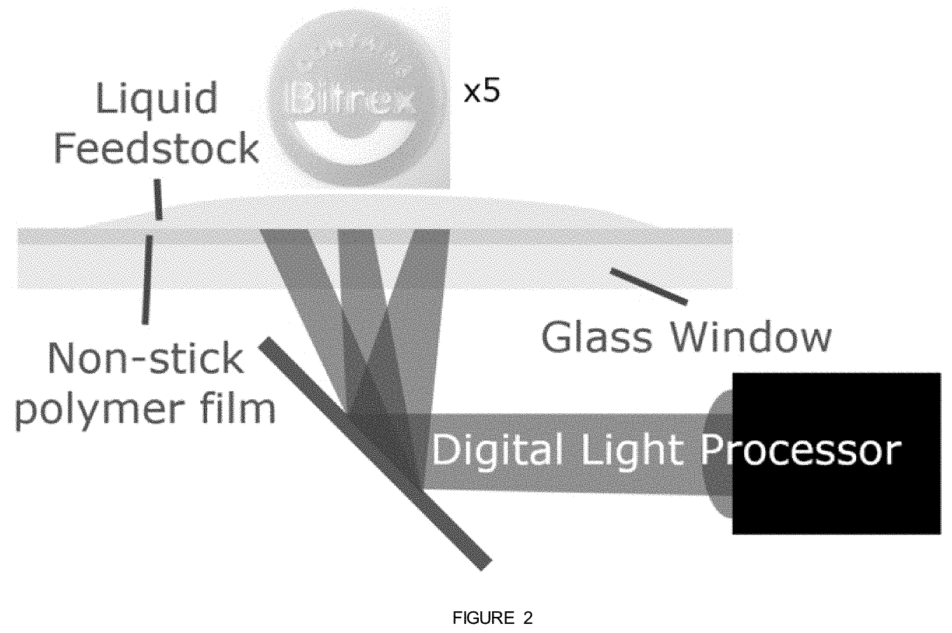

FIG. 2 shows a representative experimental set-up for curing the samples.

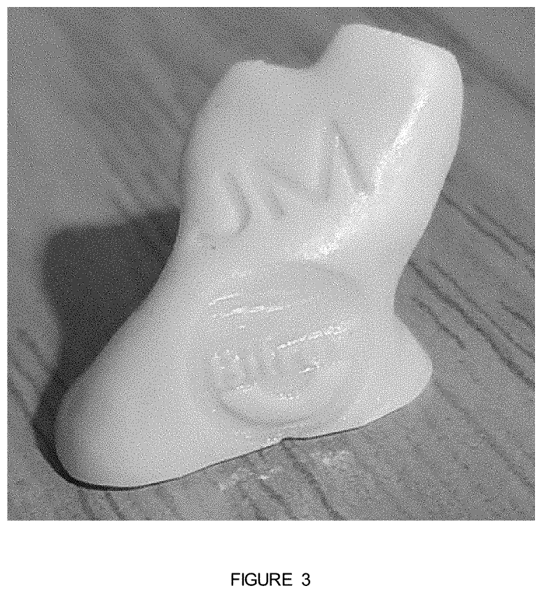

FIG. 3 shows a representative 3D object having recessed features.

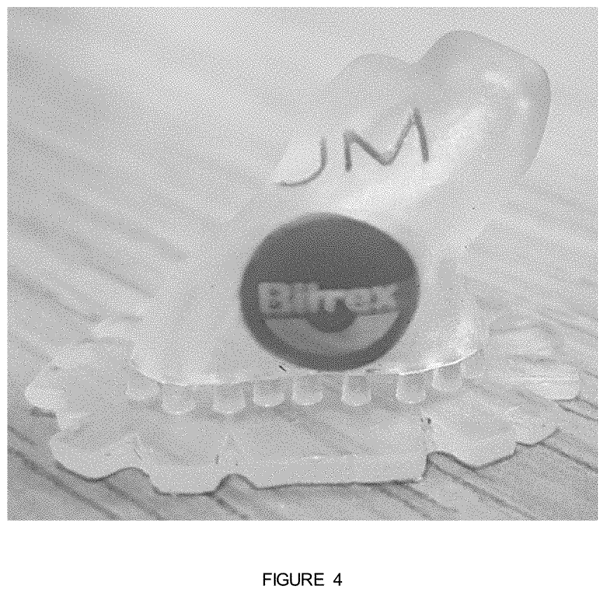

FIG. 4 shows the representative 3D object of FIG. 3 in which the recessed features contain a cured polymer containing a bittering agent. The cured polymer containing the bittering agent are identifiable as the dark areas within the “JM” and “BITREX” logos.

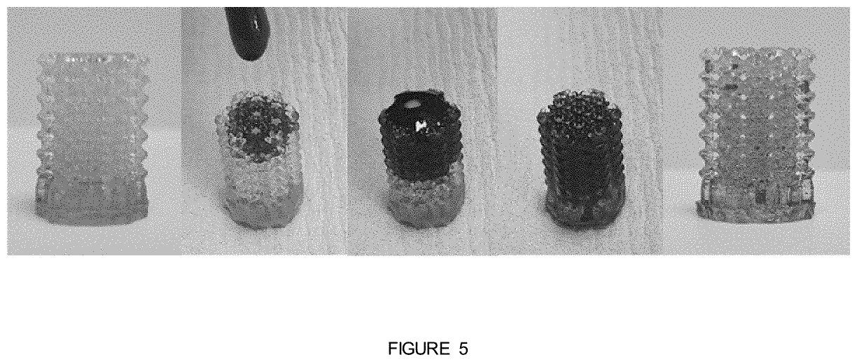

FIG. 5 shows a representative series of photographs for the stages of pre-loading, loading, saturation, removal of excess formulation, and result of Example 2, Experiment C.

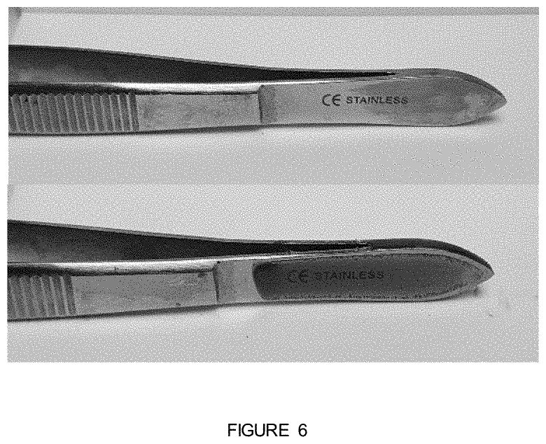

FIG. 6 shows a representative example in which the joined end of a pair of tweezers was immersed into a feedstock containing a bittering agent. The layer of feedstock was subsequently cured.

### EXAMPLES

### Example 1

General

The materials used in this experiment are sensitive to 405 nm light. To ensure that the ambient conditions did not affect the results the experiments were performed with limited light sources or the containers for preparation of the materials were shielded such that ambient light could not penetrate. The ambient light power of the laboratory has been measured to ensure that the effect of the ambient light power should be minimal but the additional measures are used to reduce the possibility.

Three representative resins were selected for initial samples. The selected resins were chosen as they possess distinct properties with respect to each other. All resins include photoinitiators tuned to 405 nm (the working wavelength of the light source on the Moonray S 3D printer) and polymeric precursors i.e. monomers/oligomers possessing acrylic functional groups. The resins are designated as follows:
CPS2030—CPS2030 is a formulated commercially available product that contains a photoinitiator and polymer precursors. This resin is available from Colorado Photopolymer Solutions.
Genesis—Moderate viscosity resin with photoinitiator, dispersant, and monomers/oligomers/cross-linkers. Supplied by Tethon 3D.
ENG1—Moderate viscosity resin with FT1—photoinitiator (2% wt), LB1—light blocker (0.2%), black pigment (0.02%), resin base (97.78%—consisting of oligomers and blue pigment). Supplied by Resyner Technologies Ltd.

CPS2030 and Genesis are resins that are incomplete formulations i.e. they are intended to have other materials added to complete them. These have been selected to determine the feasibility of incorporating denatonium benzoate into the most basic component of these formulations. ENG1 can be considered a complete formulation that represents a feedstock material from which a potential product could be constructed.

Denatonium benzoate was supplied as Bitrex™ from Johnson Matthey PLC.

Three forms of denatonium benzoate were provided:
Solid—anhydrous crystals of pure denatonium benzoate which was ground to a fine powder for incorporation into the resins;
25% solution of denatonium benzoate in monoethylene glycol and was used as received;
25% solution of denatonium benzoate in propylene glycol and was used as received.

Equipment

Moonray™ S vat photopolymerisation additive layer manufacturing (VP-ALM) machine. *3D Printer.—This printer produces 3D parts by photocuring a liquid resin layer-by-layer. The part is introduced to the machine by a 3D file that has been sliced by the Rayware™ software to correspond with a defined layer thickness (for this machine 20 μm, 50 μm, or 100 μm). Other parameters for the build process are the exposure time for “attachment” or “base” layers, number of “attachment” layers, and normal layer exposure time. The base layers typically require a longer exposure time to ensure adhesion of the part to the build platform (if it is used). It is important to limit the number of base layers to the part of the geometry that is being printed that is not critical i.e. the support structure as these settings are usually not optimized for geometric accuracy. The printer has a light power of 2.8 mW·cm⁻².

The exposure time/energy flux required for curing any given material can be determined by exposing the resin at multiple energies/times and measuring the thickness of the film.

XYZ UV Curing chamber—Interlocked enclosure for post-printing curing of parts produced by 3D Printer by irradiation with 16 W 405 nm LED light array. The post-printing curing process is important as the resin is not 100% cured during the printing process as the cured film can stick to the window, or the part can warp due to shrinkage and affect subsequent layers.

Speedmixer™—is a laboratory mixing system for the rapid mixing, dispersal or pulverizing of different substances and/or chemicals, within particularly short times and with reproducible results.

Sample Preparation:

Formulations were prepared where the total mass was approximately 20 g. This was approx. 19.99 g of each resin and 0.01 g denatonium benzoate for 500 ppm and approx. 19.98 g of each resin and 0.02 g denatonium benzoate for 1000 ppm from the solid source. Prior to weighing out the solid denatonium benzoate it was ground down to a fine powder using a mortar and pestle. The crystals were soft and did not require significant energy/time to grind down. For the solutions the amount added was adjusted to ensure the same final concentration of denatonium benzoate in the formulation i.e. 19.96 g,19.92 g resin (500 ppm, 1000 ppm respectively) and 0.04 g, 0.08 g (500 ppm, 1000 ppm respectively) denatonium benzoate solution. The samples prepared with final proportions listed as determined by actual mass added to each are presented in the table below:

| | | | | | | Denatonium |
|---|---|---|---|---|---|---|
| | | | Denatonium | | | Benzoate |
| | Denatonium | Resin | Benzoate | Ethylene | Propylene | Concentration |
| Resin | Benzoate Form | mass (%) | mass (%) | Glycol (%) | Glycol (%) | (ppm) |
| Genesis | — | 100.000 | 0.000 | — | — | 0 |
| CPS2030 | — | 100.000 | 0.000 | — | — | 0 |
| ENG1 | — | 100.000 | 0.000 | — | — | 0 |
| Genesis | Solid | 99.946 | 0.054 | — | — | 539 |
| CPS2030 | Solid | 99.951 | 0.049 | — | — | 490 |
| ENG1 | Solid | 99.951 | 0.049 | — | — | 493 |
| Genesis | Ethylene Glycol | 99.788 | 0.053 | 0.159 | — | 530 |
| | solution | | | | | |
| CPS2030 | Ethylene Glycol | 99.800 | 0.050 | 0.150 | — | 500 |
| | solution | | | | | |
| ENG1 | Ethylene Glycol | 99.799 | 0.050 | 0.151 | — | 503 |
| | solution | | | | | |
| Genesis | Propylene | 99.805 | 0.049 | — | 0.146 | 487 |
| | Glycol solution | | | | | |
| CPS2030 | Propylene | 99.801 | 0.050 | — | 0.149 | 498 |
| | Glycol solution | | | | | |
| ENG1 | Propylene | 99.802 | 0.049 | — | 0.148 | 494 |
| | Glycol solution | | | | | |
| Genesis | Solid | 99.900 | 0.100 | — | — | 1004 |
| CPS2030 | Solid | 99.900 | 0.100 | — | — | 998 |
| ENG1 | Solid | 99.900 | 0.100 | — | — | 1004 |
| Genesis | Ethylene Glycol | 99.605 | 0.099 | 0.296 | — | 987 |
| | solution | | | | | |
| CPS2030 | Ethylene Glycol | 99.580 | 0.105 | 0.315 | — | 1050 |
| | solution | | | | | |
| ENG1 | Ethylene Glycol | 99.604 | 0.099 | 0.297 | — | 991 |
| | solution | | | | | |
| Genesis | Propylene | 99.598 | 0.100 | — | 0.301 | 1005 |
| | Glycol solution | | | | | |
| CPS2030 | Propylene | 99.584 | 0.104 | — | 0.312 | 1039 |
| | Glycol solution | | | | | |
| ENG1 | Propylene | 99.599 | 0.100 | — | 0.300 | 1001 |
| | Glycol solution | | | | | |

Sample Mixing

After weighing out the components were mixed in a small Speedmixer™ pot. Each pot/formulation was mixed in the Speedmixer™ for 60 seconds at 2000 rpm. The Speedmixer™ has a capacity of >110-<150 g. Along with the sample this includes the mass of the pot, lid, and holder (approx. 110 g).

After mixing under these conditions there were no obvious signs that the materials were not thoroughly mixed i.e. no cloudiness to the clear resins or settling of the denatonium benzoate solid could be observed.

Sample Curing

For this experiment the light source of the Moonray™ 3D printer was being used to expose the resins with 405 nm light without the build platform of the printer in place. This was done as the volume of the formulations was not sufficient to 3D print whole parts from the formulations.

To initiate the print run on the printer a 3D file was loaded into the software. The software sliced the 3D file into slices that correspond to the layer thickness which was defined in the setup of the print run. In this experiment the 3D file was prepared such that it corresponded to a single layer thickness i.e. single exposure of the suitable time determined for each resin.

The 3D file and duplication of the file was setup in the print software as can be seen in FIG. 1.

As mentioned previously the volume of each formulation was not sufficient to operate the printer in full automatic mode to produce 3D parts. For this experiment the resin tank reservoir was removed from the base plate (which consists of a glass window) and a fluorinated ethylene polymer (FEP) sheet was placed on top. The polymer sheet is part of the construction of the resin tank to prevent adherence of the cured resin on the window surface.

The liquid resin was poured on top of the FEP/glass to cover the area of exposure as illustrated in FIG. 2.

The unmodified resins were used to determine a suitable exposure time for each resin where the time of exposure was controlled through the Rayware™ software. The exposure time to produce a sufficiently thick layer of each resin was:

CPS2030=7 seconds

Genesis=10 seconds

ENG1=10 seconds.

After curing the excess resin was recovered by pouring back into the Speedmixer™ pot.

The cured samples were solid enough to handle comfortably without much risk of damage. The samples were cleaned with isopropyl alcohol (2-propanol) and blotted dry with absorbent paper.

After cleaning the samples were placed between 2 glass slides and placed in the curing chamber. The glass slides were used as the samples would curl due to shrinkage of the polymer as it goes through additional cross-linking reactions under irradiation.

The samples were all cured for an additional 60 seconds inside the curing chamber. The samples were then placed in labeled zip-lock™ sample bags for storage.

Before sending, the samples were removed from their zip-lock™ bags and placed on clean, fresh aluminum foil (to prevent contamination) and subjected to another 60 second curing cycle. This was done to ensure any uncured resin was substantially reacted.

Taste Test

The samples were taste tested by four people and the denatonium benzoate-containing samples were confirmed to have a bitter taste.

### Example 2

General

The materials used in this experiment are sensitive to 405 nm light. To ensure that the ambient conditions did not affect the results the experiments were performed with limited light sources or the containers for preparation of the materials were shielded such that ambient light could not penetrate. The ambient light power of the laboratory has been measured to ensure that the effect of the ambient light power should be minimal but the additional measures are used to reduce the possibility.

Three representative resins were selected for further samples. The selected resins were chosen as they possess distinct properties with respect to each other. All resins include photoinitiators tuned to 405 nm (the working wavelength of the light source on the 3D Systems FIG. 4 Standalone 3D printer) and polymeric precursors i.e. monomers/oligomers possessing acrylic functional groups. The resins are designated as follows:
MED-WHT10—MED-WHT10 is a formulated commercially available product that contains a photoinitiator and polymer precursors. This resin is available from 3D Systems Europe Ltd.
F blue—Moderate viscosity resin with FT1—photoinitiator (2.48% wt), resin base (97.52%—consisting of oligomers and blue pigment). Supplied by Resyner Technologies Ltd.
HDT1—Moderate viscosity resin with FT1—photoinitiator (2.5% wt), LB1—light blocker (1.75%), resin base (96.5%—consisting of oligomers). Supplied by Resyner Technologies Ltd.

MED-WHT10 is a commercially available resin that is fully formulated to operate with preset conditions on 3D Systems FIG. 4 line of vat photopolymerization additive layer manufacturing (VP-ALM) equipment. 3Dresyn. F blue is provided as components (e.g. resin base, FT1, LB1—light blocker) in order to add components such as FT1 in proportions suited to the vat photopolymerization additive manufacturing equipment to be employed. The formulation prepared here did not include LB1 as with previous mixtures as it was being applied as a single layer in proof of concept experiments. HDT1 was formulated as a full VP-ALM formulation without bittering agent to produce 3D substrates for layering with bittering agent loaded resin.

Denatonium benzoate was supplied as Bitrex™ from Johnson Matthey PLC.

Two forms of denatonium benzoate were used:
Solid—anhydrous crystals of pure denatonium benzoate which was ground to a fine powder for incorporation into the resins;
25% solution of denatonium benzoate in monoethylene glycol and was used as received;

Equipment

FIG. 4™ Standalone vat photopolymerization additive layer manufacturing (VP-ALM) machine. *3D Printer.—This printer produces 3D parts by photocuring a liquid resin layer-by-layer. The part is introduced to the machine by a 3D file that has been sliced by the 3DSprint™ software to correspond with a defined layer thickness (for this machine 10 μm, 20 μm, 30 μm, 40 μm, 50 μm, or 100 μm). Other parameters for the build process are the exposure time for “base” or “attachment” layers, number of “base” layers, and normal layer exposure time. The base layers typically require a longer exposure time to ensure adhesion of the part to the build platform (if it is used). It is often important to limit the number of base layers to the part of the geometry that is being printed that is not critical i.e. the support structure as these settings are usually not optimized for geometric accuracy.

The exposure time required for curing the commercially sourced material is pre-determined by 3DSystems and included within the 3DSprint software as material profiles. Selecting a profile and layer thickness allows production of components for that material.

XYZ UV Curing chamber—Interlocked enclosure for post-printing curing of parts produced by 3D Printer by irradiation with 16 W 405 nm LED light array. The post-printing curing process may important as the resin may not 100% cured during the printing process as the cured film can stick to the window, or the part can warp due to shrinkage and affect subsequent layers.

3D Systems NextDent LC—3DPrint Box UV Curing chamber—Interlocked enclosure for post-printing curing of parts produced by VP-ALM by irradiation with 12×18 W UVA lamps. The post-printing curing process may be important as the resin may not 100% cured during the printing process as the cured film can stick to the window, or the part can warp due to shrinkage and affect subsequent layers.

Speedmixer™—is a laboratory mixing system for the rapid mixing, dispersal or pulverizing of different substances and/or chemicals, within particularly short times and with reproducible results.

Sample Preparation:

Formulations were prepared in three different approaches.

MED-WHT10 was used as received and combined with solid denatonium benzoate in the following procedure. 191.2 g of MED-WHT10 was added to a speedmixer pot with 0.96 g solid denatonium benzoate crystals. 499.6 g of 1 mm diameter yttria stabilized zirconia (YSZ) milling beads were added to the pot to break down the crystals and disperse them through the resin.

A stock solution of F blue was prepared where the total mass was approximately 20 g. This was 19.62 g of base resin, mentioned above, and 0.40 g of 25% denatonium benzoate in monoethylene glycol solution for 5000 ppm and approx. 20.02 g of total resin/denatonium benzoate mixture.

HDT1 VP-ALM resin formulation was prepared by combining the component ingredients as received in the following proportions. 6.53 g FT1, 4.53 g LB1, 250 g clear resin base.

The samples prepared with final proportions listed as determined by actual mass added to each are presented in the table below:

| | | | Denatonium | | Denatonium |
|---|---|---|---|---|---|
| | Denatonium | Resin | Benzoate | Ethylene | Benzoate |
| | Benzoate | mass | mass | Glycol | Concentration |
| Resin | Form | (%) | (%) | (%) | (ppm) |
| HDT1 | — | 100.0 | 0.0 | — | 0 |
| MED- | Solid | 99.5 | 0.5 | — | 5000 |
| WHT10 | | | | | |
| F blue | Mono- | 98.0 | 0.5 | 1.5 | 5000 |
| | ethylene | | | | |
| | Glycol | | | | |
| | solution | | | | |

Sample Mixing

For F blue and HDT1 formulations: After weighing out the components were mixed in a Speedmixer™ pot. Each pot/formulation was mixed in the Speedmixer™ for 60 seconds at 2000 rpm and 120 seconds at 1200 rpm for HDT1, respectively.

After mixing under these conditions there were no obvious signs that the materials were not thoroughly mixed i.e. no cloudiness to the clear resins or settling of the denatonium benzoate solid could be observed.

The speedmixing procedure for the MED-WHT10/denatonium benzoate mixture was carried out gradually to ensure the mixture did not overheat and damage the resin as follows:

| | Time | | |
|---|---|---|---|
| RPM | (s) | Iterations | Additional Actions |
| 800 | 30 | 1 | N/A |
| 800 | 60 | 1 | N/A |
| 1200 | 60 | 2 | Placed in refrigerator for approx. 15 min |
| 1200 | 60 | 3 | Placed in refrigerator for approx. 120 min |
| 1200 | 120 | 1 | Passed through 0.355 mm sieve to remove |
| | | | YSZ beads |

The dispersion of the solid denatonium benzoate was assessed by use of a 0-50 μm Hegman gauge. No visible sign of particulates was observed.

Sample Preparation

Each of the aforementioned formulations were prepared to test different applications of the bittering agent modified VP-ALM resins.

Experiment A—Processability of Modified Commercially Available Formulation

To initiate the print run on the printer, a 3D file was loaded into the 3D Sprint™ software. The software sliced the 3D file into slices that correspond to the layer thickness which was defined in the setup of the print run. After the VP-ALM process, excess resin was removed with compressed air. Following removal of the excess resin the 3D part was placed in the NextDent LC-3DPrint Box UV Curing chamber for 2×20 min to ensure completion of the photocuring reaction. The successful output can be seen in FIG. 3.

Experiment B—Application of Photocurable Bittering Agent Formulation to Designed Features

For this experiment the Moonray™ S 3D printer was employed to create a 3D structure from the HDT1 formulation (20 second exposure for 20 base layers (50 microns per layer) and 6 second exposure for bulk layers (50 microns per layer)). To initiate the print run on the printer a 3D file with features designed to facilitate controlled coating was loaded into the Rayware™ software. The software sliced the 3D file into slices that correspond to the layer thickness which was defined in the setup of the print run.

After successful reproduction of the 3D file with the Moonray™ S 3D printer, the 5000 ppm denatonium benzoate loaded f blue formulation was applied by pipette to the recessed features of the 3D part to control the surface areas of the part that contained the bitter, photocurable formulation. As the f blue was still liquid the recessed features were kept facing up as it was placed into the XYZ curing chamber. The coated 3D part was placed in the XYZ curing chamber for 10 minutes on full power. The successful output can be seen in FIG. 4.

Experiment C—Application of Photocurable Bittering Agent Formulation to a Surface

For this experiment the f blue formulation was deposited by dipping and/or dropping formulation to demonstrate an additive process does not need to be performed on flat surfaces or in a mask/embossed feature.

When depositing the formulation by dropping, the f blue formulation was added drop-wise to a 3D part using a disposable syringe. The surface was saturated with f blue formulation. The excess formulation was removed by gentle application of compressed air leaving a layer of liquid formulation on the inside of the part. The stages of pre-loading, loading, saturation, removal of excess formulation, and result can be seen in FIG. 5.

Depositing the formulation by dipping was demonstrated by simply dipping an item into the f blue formulation and curing in the XYZ chamber for 10 minutes on full power. The result of this can be seen in FIG. 6.

After each experiment the excess resin was recovered by pouring back into the Speedmixer™ pot.

Taste Test

The samples were taste tested by four people and the denatonium benzoate-containing samples were confirmed to have a bitter taste.

1. An additive layer manufacture method for producing a three-dimensional object, the method comprising the steps of:
(i) forming a feedstock comprising a polymerizable liquid resin and a bittering agent;
(ii) exposing the feedstock to a curing beam according to a predetermined pattern to form a layer of cured polymer; and
(iii) repeating step (ii) layer upon layer to form a cured three-dimensional polymerized object.

2. A method according to claim 1, wherein the additive layer manufacture method is electron beam curing or vat photopolymerization additive layer manufacture.

3. A method according to claim 2, wherein additive layer manufacture method is vat photopolymerization additive layer manufacture and the polymerizable liquid resin is a photocurable liquid resin.

4. A method according to claim 3, wherein the photocurable liquid resin further comprises a photoinitiator.

5. A method according to claim 4, wherein the photoinitiator has an absorption wavelength ≥about 200 nm to ≤about 700 nm.

6. A method according to claim 1, wherein the polymerizable liquid resin comprises a mixture of multifunctional monomers and oligomers functionalized by an acrylate.

7. A method according to claim 1, wherein the bittering agent is selected from the group consisting of denatonium benzoate, denatonium saccharide, quinine hydrochloride, naringin, sucrose octaacetate and mixtures thereof.

8. A method according to claim 7, wherein the bittering agent is denatonium benzoate.

9. A method according to claim 8, wherein the concentration of bittering agent in the feedstock is from about 100 ppm to about 10,000 ppm, such as about 100 ppm to about 5000 ppm.

10. A method according to claim 9, wherein the concentration of bittering agent in the feedstock is from ≥about 500 ppm to ≤1100 ppm.

11. A method according to claim 1, wherein the curing beam is electromagnetic radiation having a wavelength ≥about 200 nm to ≤about 700 nm.

12. A method according to claim 11, wherein the electromagnetic radiation has a wavelength of about 365 nm, about 405 nm, or about 460 nm.

13. A method according to claim 11, wherein the exposure time for the curing beam is about 1 second to about 60 seconds.

14. An additive layer manufacture method for producing an object comprising cured polymer on, in and/or around the object, or part thereof, the method comprising the steps of:
(i) forming a feedstock comprising a polymerizable liquid resin and a bittering agent;
(ii) immersing an object, or part thereof, into the feedstock;
(iii) exposing the feedstock to a curing beam according to a predetermined pattern to form a layer of cured polymer on, in and/or around the object, or part thereof; and
(iv) optionally repeating step (iii) layer upon layer to form an object comprising cured polymer on, in and/or around the object, or part thereof.

15. An additive layer manufacture method for producing an object comprising cured polymer on, in and/or around the object, or part thereof, the method comprising the steps of:
(i) forming a feedstock comprising a polymerizable liquid resin and a bittering agent;
(ii) depositing the feedstock onto, in and/or around an object, or part thereof according to a predetermined pattern;
(iii) exposing the feedstock to a curing beam to form a layer of cured polymer on, in and/or around the object, or part thereof; and
(iv) optionally repeating step (iii) layer upon layer to form an object comprising cured polymer on, in and/or around the object, or part thereof.

16. (canceled)

17. A cured 3D polymerized object produced according to the method according to claim 1, wherein the cured 3D polymerized object comprises a bittering agent distributed within the cured polymer.

18. A cured 3D polymerized object, wherein the object comprises a cured polymer and a bittering agent, the object comprising multiple layers of individually cured polymer, and the bittering agent is distributed within the individually cured polymer layers.

19. A cured 3D polymerized object according to claim 17, wherein the bittering agent is distributed substantially homogeneously within the individually cured polymer layers.

20. A cured 3D polymerized object according to claim 19, wherein the object is a shell for an in-ear hearing aid.

21. An object, or part thereof, comprising multiple layers of individually cured polymer on, in and/or around the object, or part thereof, wherein a bittering agent is distributed within the individually cured polymer layers.

22. An object according to claim 21, wherein the bittering agent is distributed substantially homogeneously within the individually cured polymer layers.

23. A feedstock comprising a polymerizable liquid resin and a bittering agent.

24. (canceled)
